(19) United States
(12) Patent Application Publication
(10) Pub. No.: US 2014/0089507 A1
(43) Pub. Date: Mar. 27, 2014

(54) APPLICATION INDEPENDENT CONTENT CONTROL

(71) Applicants: Gyan Prakash, Beaverton, OR (US); Jiphun Satapathy, Portland, OR (US); Saurabh Dadu, Tigard, OR (US); Rajesh Poornachandran, Portland, OR (US)

(72) Inventors: Gyan Prakash, Beaverton, OR (US); Jiphun Satapathy, Portland, OR (US); Saurabh Dadu, Tigard, OR (US); Rajesh Poornachandran, Portland, OR (US)

(21) Appl. No.: 13/627,756

(22) Filed: Sep. 26, 2012

(51) Int. Cl. G06F 15/173; G06F 17/30

(52) U.S. Cl. 709/225; 707/754; 707/E17.001

(57) ABSTRACT

Systems and techniques for application independent content control are described herein. It may be determined that a content filter is enabled for a computing device. The content filter may include a restricted term. A content container may be identified in a device buffer of the computing device. The content container may also include the restricted term. A portion of the content container corresponding to the restricted term may be modified in the device buffer to block the restricted term.

### BACKGROUND

As modern computing devices become less expensive, more robust, and easier to use, these devices are being used by more and more children. The sophisticated communication technology in today's computing devices also provides a variety of readily available information and applications that were previously difficult to access. Mobile computing devices may provide children with powerful data access tools away from a steward's (e.g., parent, guardian, teacher, etc.) watchful eye.

To police the content to which a child may be exposed, a steward may, for example, implement universal resource locator (URL) blocking at an internet service provider (ISP) or a web browser on a computing device. In an example, the steward may restrict a mobile computing device's contacts to whom a short message service (SMS) message may be sent or from whom such a message may be received. In an example, the steward may install a key logger on the computing device to track what the child may be entering, for example, in a message or email. In an example, the steward may enable and set-up some or all application specific content management options in any of a variety of applications, if such options exist.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a computing device implementing application independent content control, according to an embodiment.

FIG. 2 illustrates an example of a computing device implementing application independent content control, according to an embodiment.

FIG. 3 illustrates an example of an environment for application independent content control, according to an embodiment.

FIG. 4 illustrates an example of a method for application independent content control, according to an embodiment.

FIG. 5 is a block diagram illustrating an example of a machine upon which one or more embodiments may be implemented.

### DETAILED DESCRIPTION

Existing efforts to control the content children may be exposed to on a computing device, such as those discussed above, often fall short. For example, the crude URL based ISP (or Domain Name Service (DNS)) techniques may be prone to being out-of-date as URLs change. Also, these techniques may be too crude to allow access to desirable content and deny such access to objectionable content. An example of this scenario may be a reference source, such as an online encyclopedia with community drafted articles. Any number of valuable articles may be inaccessible to a child if the URL blocking prevents access to the encyclopedia to block a specific objectionable article.

Because a key logger simply records which keys are pressed by a user, using a key logger to monitor a child's content activities may be both time consuming for the steward and fail to identify actual exposure of such content to the child, much less actually prevent that exposure. Finally, setting up individual content settings for each application may be unavailable to the steward and, where available, may present a byzantine task of setting a myriad of different content settings for every application.

Thus, some existing techniques to control child accessible content rely on a proxy for that content (e.g., URL filtering) or are specific to a particular application. As discussed, neither adequately addresses a steward's desire to control content to which the child may be exposed. Rather, a solution lies in a content aware technique that operates outside of a particular application, for example, on the computing device. For example, textual content may be intercepted at a network buffer, or a device input buffer, and modified to remove a restricted term. In an example, optical character recognition (OCR) may be performed on a display buffer to identify a portion of the display in which the restricted term will appear, and then modify that portion to redact the term (e.g., cover the term with a black box). In an example, one or more network components may be implemented in a cloud (e.g., via a proxy). By accessing and modifying content containers in this way, content filtering based on the content itself may be accomplished in an application independent manner. In fact, such filtering may be accomplished such that applications are unaware that any filtering of restricted terms has occurred.

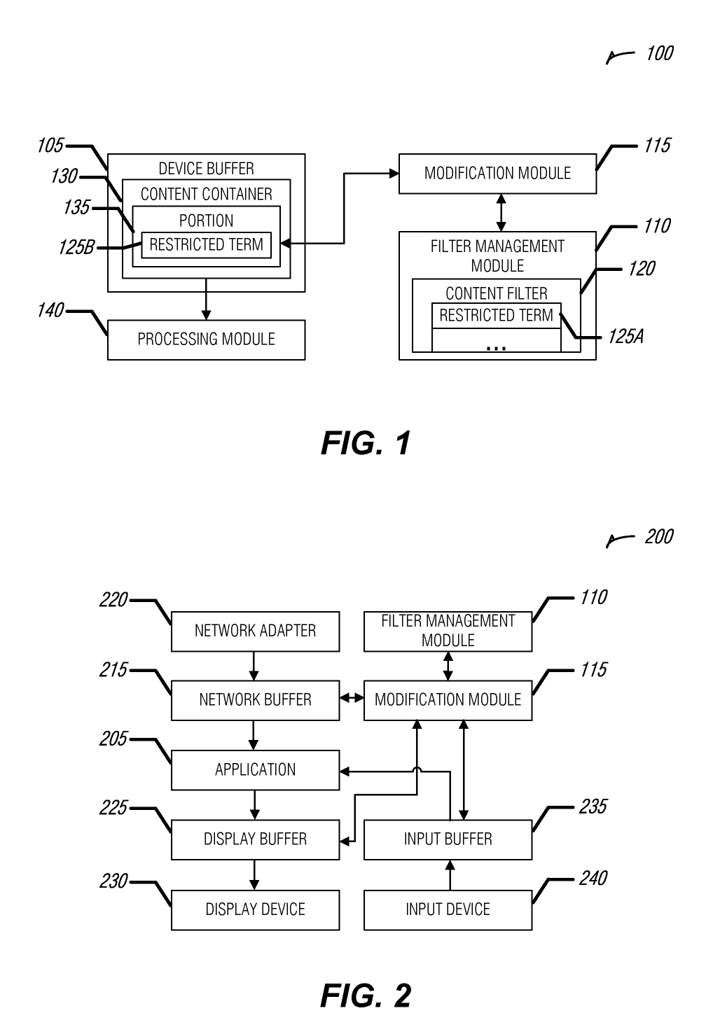

FIG. 1 illustrates an example of a computing device 100 implementing application independent content control. Computing device 100 may include a device buffer 105, a filter management module 110, a modification module 115, and a processing module 140.

The filter management module 110 may include a content filter 120. The content filter 120 may include a restricted term 125A. In an example, the content filter may include more than the single restricted term 125A. In an example, the content filter 120 may be arranged to be enabled for the computing device 100 without regard to applications that are running, installed, or both on the computing device 100. In an example, the content filter 120 may be arranged to store a pattern of the restricted term 125A. In an example, the pattern is a regular expression to which restricted term 125A matches. In an example, content filter 120 may store an action to be performed for the restricted term 125A. For example, the action may include removing the restricted term 125A, covering up the restricted term (e.g., with a “bleep” graphic or term), or replacing the restricted term 125A. In an example, the content filter 120 may include a term replacement corresponding to the restricted term 125A. In an example, the restricted term 125A is limited to a textual term and not, for example, an audible term. In an example, the restricted term may be a restricted token. In an example, the restricted term may be a restricted object. In these examples, the restricted term is not limited to text, but may include other data, such as still images, audio, or video content.

In an example, the filter management module 110 may include a user interface arranged to permit, for example, a steward to add, remove, or edit the restricted term 125A. In an example, the user interface may be arranged to permit the steward to enable the content filter 120 for the computing device 100. In an example, the user interface maybe arranged to permit the steward to specify to which of a plurality of applications the content filter 120 will apply.

The device buffer 105 may be a hardware storage device specific to a device, such as a network interface card (NIC) memory or a graphics processing unit (GPU) memory, among others. In an example, the device buffer 105 may be a portion of a shared storage device to which a device will deposit or collect data, such as a rendering buffer in system memory or an output buffer to a NIC. Regardless of the particular location of the device buffer 105 within the computing device 100, the device buffer 105 is communicatively coupled to the modification module 115.

The device buffer 105 may include a content container 130. The content container 130 may be a data structure arranged to encapsulate content. In an example, the content container may be all or a portion of a structured document. In an example, the structured document may be a standard generalized markup language (SGML) document or a derivative of SGML (e.g., hypertext markup language (HTML) or extensible markup language (XML)). In an example, the content container 130 may be a system message. For example, the content container 130 may be a data structure generated by a host operating system of the computing device 100. In an example, the content container 130 may be a packet from one or more network layers.

The content container 130 may include a portion 135 of itself corresponding to the restricted term 125B. Restricted terms 125A and 125B are semantically the same or otherwise equivalent but do not necessarily refer to the same object (e.g., bits) in the computing device 100. For example, if the restricted term 125A is “HATE” represented in American standard code for information interchange (ASCII) in a memory of the filter management module 110, restricted term 125B is also “HATE” even though it may be in Unicode in a NIC buffer. Equivalence between the restricted term 125A and 125B may include any way in which a processing device can match restricted term 125A to 125B. For example, the restricted term 125A may be represented as the regular expression “HAT(E(RID)?IING)”. This regular expression represents the terms “HATE”, “HATER”, “HATED”, and “HATING”. Thus, in this example, restricted term 125A is equivalent to any of these derivations of the word “HATE”.

In an example, the portion 135 of the content container 130 may be the representation of the restricted term 125B itself. For example, the portion 135 may be the ASCII characters in an HTML document of the restricted term 125B. Further, the portion 135 may be the pixels in an image that, when viewed in a display device, compose the restricted term 125B or immediately surround the restricted term 125B, such as a rectangle that covers the composition pixels. In an example, the portion 135 may be a component of the content container 130 to which the restricted term 125B may be unambiguously connected. For example, in an HTML document, an image tag (e.g., <img>) may include an attribute commenting on or providing a description of the image itself that contains the restricted term 125B. In this example, the portion 135 includes the image tag itself. Thus, the image is included in the portion 135. In an example, the portion 135 is limited to still, textual representations of the restricted term 125B. In an example, the portion 135 is not video. In an example, the portion 135 is not audio.

In an example, the portion 135 may include renderable content. Renderable content is that which can be displayed (including being printed) to a user. In an example, renderable content may not include control characters, or other information that would not be displayed to a user in ordinary use of the content container 130. Examples may include HTML tag attributes, network packet headers, and the like. In an example, the renderable content does not include video. In an example, the renderable content does not include audio.

The modification module 115 may be communicatively coupled to both the filter management module 110 and the device buffer 105. The modification module 115 may be arranged to determine that the content filter 120 is enabled for the computing device 100. The modification module 115 may also be arranged to identify the content container 130 in the device buffer 105. For example, the modification module 115 may be arranged to monitor the device buffer 105, when the content filter 120 is enabled, for the restricted term 125B in a content container 130. In an example, the modification module 115 may access the bits in the device buffer 105 directly. In an example, the device buffer 105 may be arranged to copy some or all of the bits to another location such that the modification module 115 can view those bits. In an example, to perform the content container 130 identification, the modification module 115 may be arranged to perform OCR on a display buffer to extract textual components of the image to be rendered on the corresponding display device.

The modification module 115 may be arranged to modify the content container 130 to block the restricted term 125B. Blocking the restricted term 125B entails the prevention of restricted term 125B from exiting the device buffer 105 except, in an example, via the modification module 115. This exception allows the modification module 115 to log (e.g., record) the incidence of the restricted term 125B, in an example. In an example, the modification module 115 may be arranged to log one or more details of an occurrence of the restricted term 125B. In an example, the modification module 115 may be arranged to log details of the portion 135 of the content container 130 to which a modification was, or may be, performed. In an example, the modification module 115 may be arranged to log the actual change performed, or planned to be performed, on the portion 135 of the content container 130. In an example, the modification module 115 may be arranged to alert a user of one or more details of an occurrence of the restricted term 125B. In an example, the modification module 115 may be arranged to alert the user about details of the portion 135 of the content container 130 to which a modification was, or may be, performed. In an example, the modification module 115 may be arranged to alert the user about the actual change performed, or planned to be performed, on the portion 135 of the content container 130. In an example, to perform the alert, the modification module 115 may be arranged to display a message to a display device of the computing device 100. In an example, to perform the alert, the modification module 115 may be arranged to send a report to the user via a messaging service (e.g., email, SMS, etc.).

To block the restricted term 125B, the modification module 115 may be arranged to change the portion 135 of the content container 130 corresponding to the restricted term 125B. Such changes may include any modification, for example, of bits to transform or remove the restricted term 125B from the device buffer 105. In an example, the change, or the portion 135, may be restricted to those that, while addressing the restricted term 125B, do not damage the data structure of the content container 130. For example, if the content container 130 is an HTML file, the change may be restricted to deleting an entire element (e.g., attribute or tag), because removing only a portion may result in a violation of the underlying document standard. In an example, the change may include removing the bits composing the restricted term 125B, such as removal of the ASCII characters from which the restricted term 125B is composed. In an example, the change may include the changing of bits in the portion 135, such as the change of the ASCII characters composing the restricted term 125B so that these characters now represent a different semantic concept (e.g., changing “HATE” into “LOVE”). Further, in the example of a display buffer, the bits may be changed to mask, or cover the restricted term 125B, such as by changing a rectangular (or other shape) area of the display buffer containing the restricted term into a single solid color. In an example, where the portion 135 contains renderable content, the modification to the content container 130 may be arranged to prevent a renderer of the content container from rendering the restricted term 125B. For example, the portion 135 may be restricted to the above techniques acting on the renderable content and not on other content in the content container 130.

The processing module 140 may be arranged to use the content container 130. For example, the processing module 140 may be a component of the computing device 100 that will receive the contents of the device buffer 105 in due course of operation. Thus, the device buffer 105 may be arranged to store the content container 130 prior to delivery of the content container 130 to the processing module 140. This arrangement permits redaction of the restricted term 125B before it can impact a user (e.g., a child) regardless of the processing module's 140 operation. Other examples of device buffers 105 and corresponding processing module's 140 are discussed below.

FIG. 2 illustrates an example of a computing device 200 implementing application independent content control. The illustrated elements correspond to one or more components of computing device 100 and operate similarly. For example, the filter management module 110 and the modification module 115 operate as described above. The network buffer 215, input buffer 235, and display buffer 225 are all examples of the device buffer 105 described with respect to computing device 100. Thus, FIG. 2 illustrates an example arrangement of the components of a typical computing device 200.

The directionality of data flow may be important with respect to a specific device, device buffer 105, and processing module 140. Thus, for example, for a network adapter 220 (e.g., NIC) device, the device buffer is the network buffer 215, and the processing module 140 is the application (e.g., game) 205. However, in an example, the application 205 may be the device, the display buffer 225 may be the device buffer 105, and the display device 230 may be the processing module 140. Accordingly, the ultimate characterization of any one component may depend on its position in the flow of data.

In an example, the device buffer 105 is the display buffer 225. In this example, the processing module 140 may be arranged to render content on the display device 230. In an example, the device buffer 105 may be a user interface input buffer 235. In this example, the processing module 140 may be arranged to deliver user input to the application 205 via an input device 240. In an example, the input device 240 may be a keyboard. In an example, the keyboard may be a soft-keyboard actuated by a touchscreen device. In this example, the input device 240 may be considered a logical device comprising sensing hardware (e.g., the touchscreen) and software to create the input device 240. However, the application 205 may not be aware of the specific nature of the input device 240 because the data is accessed or delivered via a standard technique of the host operating system for input devices.

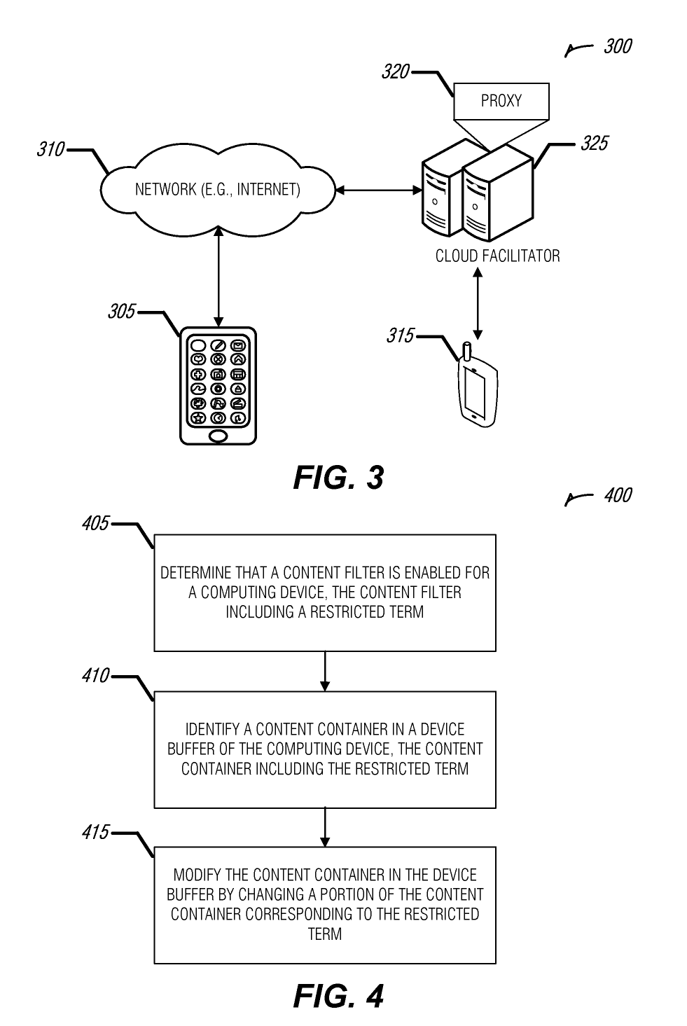

In an example, the device buffer 105 may be the network buffer 215. In this example, the processing module 140 may be arranged to deliver network traffic to the application 205. In an example, the application 205 is a web browser. In an example, the web browser may be configured to use a proxy for encrypted communications. The proxy may be at a machine remote from the computing device 200 executing the web browser. The proxy may be configured to make encrypted web requests on behalf of the web browser and receive encrypted responses directed toward the web browser. Thus, in this example, encrypted web communications may be made while allowing for unencrypted data to be received at the computing device 200 such that the network buffer 215 may be processed by the modification module 115. An example of this environment is described below with respect to FIG. 3.

Operating on either the network buffer 215 or the input buffer 235 for an input device 240 permits the modification module 115 to block the restricted term 125B before it reaches the application 205. Thus, the application 205 need never process the restricted term 125B. However, if, for example, the application 205 created the restricted term 125B—or otherwise extracted the restricted term 125B from received data in way unfamiliar to the modification module 115—operating on the display buffer 225 provides a stop-gap measure to prevent display of the restricted term 125B to a user. An example in which this may be useful is in the receipt of encrypted data by the application 205. If the modification module cannot decrypt the data, then identifying the restricted term 125B in the content container 130 will be difficult. Operating on the display buffer 225 permits the modification module 115 to block the restricted term 125B without regard for the nature of the data received by the application 205, or any attempt by the application 205 to render the restricted term 125B because such intervention by the modification module 115 occurs after control of the data has left the application 25.

FIG. 3 illustrates an example of an environment 300 for application independent content control. Environment 300 may include computing device 305 (e.g., a tablet), computing device 315 (e.g., a smart phone), a cloud facilitator 325 including a proxy 320, and a network 310 (e.g., the Internet). In an example, computing device 305 interacts directly with the network 310 in any of the ways described above with respect to computing devices 100 and 200.

In an example, computing device 315 interacts with the network 310 via the cloud facilitator 325. In an example, the computing device 315 uses the proxy 320 for any network communications. The proxy 320 may be arranged to encrypt outgoing communications to the network 310 and decrypt incoming communications from the network 310. An example of this operation with respect to web communications is described above with respect to FIG. 2. In an example, the cloud facilitator 325 may include one or more components described above with respect to computing devices 100 and 200. For example, the cloud facilitator may include the modification module 115, or an analogous component, to modify content containers 130 as they flow to the computing device 315. In an example, the cloud facilitator 325 may include the filter management module 110, or may store the content filter 120 (or a copy of it). In an example, the cloud facilitator 325 may be arranged to query the filter management module 110 on the computing device 315 to determine the contents of the content filter 120 or whether the content filter 120 is enabled for the computing device 315. In an example, the cloud facilitator 325 may include a push module to push content filter contents or enablement instructions down to the computing device 315.

FIG. 4 illustrates an example of a method 400 for application independent content control. The operations of method 400 may be performed in whole or part by one or more components described above with respect to FIGS. 1-3.

At operation 405, it is determined that a content filter 120 is enabled for a computing device. The content filter 120 includes a restricted term 125A. In an example, the content filter 120 is enabled for the computing device without regard for user-level applications that are at least one of running or installed on the computing device.

At operation 410, a content container 130 in a device buffer 105 is identified. The content container 130 includes the restricted term 125B. In an example, the device buffer 105 is arranged to store the content container 130 prior to delivery of the content container 130 to a processing module 140. In an example, the device buffer 105 is a display buffer 225, and the processing module 140 is arranged to render the content container 130 on a display device 230.

In an example, the device buffer 105 is a network buffer 215, and the processing module 140 is arranged to deliver network traffic to an application 205. In an example, the application 205 is a web browser. In an example, the web browser is configured to use a proxy 320 for encrypted communications. The proxy 320 is at a machine (e.g., a component of cloud facilitator 325) remote from a machine executing the web browser (e.g., computing device 315). The proxy 320 is arranged to make encrypted web requests on behalf of the web browser and to receive and decrypt encrypted responses directed toward the web browser.

In an example, the device buffer 105 is a user interface input buffer 235, and the processing module is arranged to deliver user input to the application 205 for a user input device 240. In an example, the user input device 240 is a keyboard. In an example, the keyboard is a soft keyboard actuated by a touchscreen device.

At operation 415, the content container 130 is modified in the device buffer 105 to block the restricted term 125B. The modification is performed by changing a portion 135 of the content container 130 corresponding to the restricted term 125B. In an example, the portion 135 of the content container 130 includes renderable content, and the modification is arranged to prevent a renderer or the content container 130 from rendering the restricted term 125B.

In an example, modifying the content container 130 includes logging details of at least one of an occurrence of the restricted term 125A or 125B, the portion 135 of the content container 130, or a change performed on the portion 135 of the content container 130. In an example, modifying the content container 130 includes alerting the user to at least one of an occurrence of the restricted term 125A or 125B, the portion 135 of the content container 130, or a change performed on the portion 135 of the content container 130. In an example, the alerting (e.g., by the modification module 115) includes at least one of displaying a message to a display device 230 of the computing device or sending a report to the user via a messaging service.

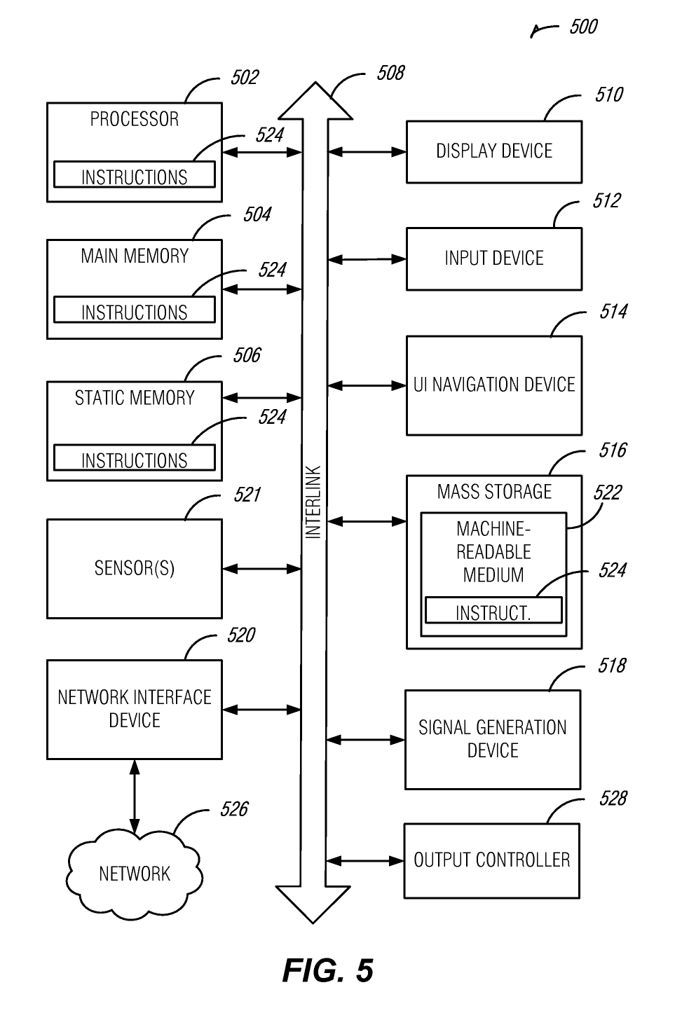

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared(IR)) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) that arranged to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, and IEEE 802.16 family of standards known as WiMax®), and peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES & EXAMPLES

Example 1 may include subject matter (such as a method, means for performing acts, or machine readable medium including instructions that, when performed by a machine cause the machine to performs acts) comprising determining that a content filter is enabled for a computing device, the content filter including a restricted term, identifying a content container in a device buffer of the computing device where the content container may include the restricted term, and modifying the content container in the device buffer to block the restricted term by changing a portion of the content container corresponding to the restricted term.

In Example 2, the subject matter of Example 1 may optionally include the device buffer being arranged to store the content container prior to delivery of the content container to a processing module.

In Example 3, the subject matter of Example 2 may optionally include the device buffer being a display buffer, and the processing module arranged to render the content container on a display device.

In Example 4, the subject matter of Example 2 may optionally include the device buffer being a network buffer, and the processing module arranged to deliver network traffic to an application.

In Example 5, the subject matter of Example 4 may optionally include the application being a web browser.

In Example 6, the subject matter of Example 5 may optionally include the web browser arranged to use a proxy for encrypted communications. The proxy may be at a machine remote from a machine executing the web browser, and the proxy may be arranged to make encrypted web requests on behalf of the web browser and to receive and decrypt encrypted responses directed toward the web browser.

In Example 7, the subject matter of one or more of Examples 2-6 may optionally include the device buffer being a user interface input buffer for a user input device, and the processing module arranged to deliver user input to an application.

In Example 8, the subject matter of Example 7 may optionally include the user input device being a keyboard.

In Example 9, the subject matter of Example 8 may optionally include the keyboard being a soft-keyboard actuated by a touchscreen device.

In Example 10, the subject matter of one or more of Examples 1-9 may optionally include the portion of the content container including renderable content, and the modification being arranged to prevent a renderer of the content container from rendering the restricted term.

In Example 11, the subject matter of one or more of Examples 1-10 may optionally include the content filter being enabled for the computing device without regard for user-level applications that are at least one of running or installed on the computing device.

In Example 12, the subject matter of one or more of Examples 1-11 may optionally include modifying the content container including logging details of at least one of an occurrence of the restricted term, the portion of the content container, or a change performed on the portion of the content container.

In Example 13, the subject matter of one or more of Examples 1-12 may optionally include modifying the content container including alerting the user to at least one of an occurrence of the restricted term, the portion of the content container, or a change performed on the portion of the content container.

In Example 14, the subject matter of Example 13 may optionally include the alerting to include at least one of displaying a message to a display device of the computing device or sending a report to the user via a messaging service.

Example 15 may include, or may optionally be combined with the subject matter of one or any of Examples 1-14 to include, subject matter (such as a device, apparatus, or computing device for application independent content control) comprising a device buffer, a filter management module including a content filter with a restricted term, and a modification module. The modification module may be arranged to determine that the content filter is enabled for the computing device, identify a content container in the device buffer where the content container may include the restricted term, and modify the content container to block the restricted term by changing a portion of the content container that corresponds to the restricted term.

In Example 16, the subject matter of Example 15 may optionally include a processing module arranged to use the content container, and the device buffer arranged to store the content container prior to delivery of the content container to the processing module.

In Example 17, the subject matter of Example 16 may optionally include the device buffer being a display buffer, and the processing module arranged to render the content container on a display device.

In Example 18, the subject matter of Example 16 may optionally include the device buffer being a network buffer, and the processing module arranged to deliver network traffic to an application.

In Example 19, the subject matter of Example 18 may optionally include the application being a web browser.

In Example 20, the subject matter of Example 16 may optionally include the device buffer being a user interface input buffer for a user input device, and the processing module arranged to deliver user input to an application.

In Example 21, the subject matter of one or more of Examples 15-20 may optionally include the portion of the content container including renderable content, and the modification arranged to prevent a renderer of the content container from rendering the restricted term.

In Example 22, the subject matter of one or more of Examples 15-21 may optionally include the content filter arranged to be enabled for the computing device without regard to user-level applications that are at least one of running or installed on the computing device.

In Example 23, the subject matter of one or more of Examples 15-22 may optionally include the modification module arranged to log details of at least one of an occurrence of the restricted term, the portion of the content container, or a change performed on the portion of the content container to modify the content container.

In Example 24, the subject matter of one or more of Examples 15-23 may optionally include the modification module arranged to alert a user to at least one of an occurrence of the restricted term, the portion of the content container, or a change performed on the portion of the content container to modify the content container.

In Example 25, the subject matter of Example 24 may optionally include the modification module arranged to at least one of display a message to a display device of the computing device or send a report to the user via a messaging service to implement the alert.

Example 26 may include, or may optionally be combined with the subject matter of any one of Examples 1-25 to include, subject matter (such as a method, means for performing acts, or machine readable medium including instructions that, when performed by a machine cause the machine to performs acts) comprising determining that a content filter is enabled for a computing device, the content filter including a restricted term, identifying a content container in a device buffer of the computing device where the content container may include the restricted term, and modifying the content container in the device buffer to block the restricted term by changing a portion of the content container corresponding to the restricted term.

In Example 27, the subject matter of Example 26 may optionally include the device buffer arranged to store the content container prior to delivery of the content container to a processing module.

In Example 28, the subject matter of Example 27 may optionally include the device buffer being a display buffer, and the processing module arranged to render the content container on a display device.

In Example 29, the subject matter of Example 27 may optionally include the device buffer being a network buffer, and the processing module arranged to deliver network traffic to an application.

In Example 30, the subject matter of Example 29 may optionally include the application being a web browser.

In Example 31, the subject matter of Example 30 may optionally include the web browser arranged to use a proxy for encrypted communications. The proxy may be at a machine remote from a machine executing the web browser. The proxy may be arranged to make encrypted web requests on behalf of the web browser and to receive and decrypt encrypted responses directed toward the web browser.

In Example 32, the subject matter of Example 27 may optionally include the device buffer being a user interface input buffer for a user input device, and the processing module arranged to deliver user input to an application.

In Example 33, the subject matter of Example 32 may optionally include the user input device being a keyboard.

In Example 34, the subject matter of Example 33 may optionally include the keyboard being a soft-keyboard actuated by a touchscreen device.

In Example 35, the subject matter of one or more of Examples 26-34 may optionally include the portion of the content container including renderable content, and the modification arranged to prevent a renderer of the content container from rendering the restricted term.

In Example 36, the subject matter of one or more of Examples 26-35 may optionally include the content filter enabled for the computing device without regard for user-level applications that are at least one of running or installed on the computing device.

In Example 37, the subject matter of one or more of Examples 26-36 may optionally include logging details of at least one of an occurrence of the restricted term, the portion of the content container, or a change performed on the portion of the content container, to modify the content container.

In Example 38, the subject matter of one or more of Examples 26-37 may optionally include alerting the user to at least one of an occurrence of the restricted term, the portion of the content container, or a change performed on the portion of the content container, to modify the content container.

In Example 39, the subject matter of Example 38 may optionally include the alerting to include at least one of displaying a message to a display device of the computing device or sending a report to the user via a messaging service.

In Example 40, the subject matter of one or more of Examples 26-39 may optionally include the content filter storing an action to be performed for the restricted term.

In Example 41, the subject matter of Example 40 may optionally include the action being one of removing the restricted term, covering up the restricted term, or replacing the restricted term.

In Example 42, the subject matter of one or more of Examples 26-41 may optionally include a filter management module arranged to permit a user to at least one of add, remove, or edit the restricted term.

In Example 43, the subject matter of one or more of Examples 26-42 may optionally include blocking the restricted term by preventing the restricted term from exiting the device buffer.

The above detailed description includes references to the accompanying drawings, which form a part of the detailed description. The drawings show, by way of illustration, specific embodiments in that may be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The above description is intended to be illustrative and not restrictive. For example, the above-described examples (or one or more aspects thereof) may be used in combination with each other. Other embodiments can be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A machine-readable medium including instructions that, when executed by a machine, cause the machine to perform operations comprising:
determining that a content filter is enabled for a computing device, the content filter including a restricted term;
identifying a content container in a device buffer of the computing device, the content container including the restricted term; and
modifying the content container in the device buffer to block the restricted term by changing a portion of the content container corresponding to the restricted term.

2. The machine-readable medium of claim 1, wherein the device buffer is arranged to store the content container prior to delivery of the content container to a processing module.

3. The machine-readable medium of claim 2, wherein the device buffer is a display buffer; and
wherein the processing module is arranged to render the content container on a display device.

4. The machine-readable medium of claim 2, wherein the device buffer is a network buffer; and
wherein the processing module is arranged to deliver network traffic to an application.

5. The machine-readable medium of claim 4, wherein the application is a web browser.

6. The machine-readable medium of claim 5, wherein the web browser is arranged to use a proxy for encrypted communications, the proxy at a machine remote from a machine executing the web browser, the proxy arranged to make encrypted web requests on behalf of the web browser and to receive and decrypt encrypted responses directed toward the web browser.

7. The machine-readable medium of claim 2, wherein the device buffer is a user interface input buffer for a user input device; and
wherein the processing module is arranged to deliver user input to an application.

8. The machine-readable medium of claim 7, wherein the user input device is a keyboard.

9. The machine-readable medium of claim 8, wherein the keyboard is a soft-keyboard actuated by a touchscreen device.

10. The machine-readable medium of claim 1, wherein the portion of the content container includes renderable content; and
wherein the modification is arranged to prevent a renderer of the content container from rendering the restricted term.

11. The machine-readable medium of claim 1, wherein the content filter is enabled for the computing device without regard for user-level applications that are at least one of running or installed on the computing device.

12. A computing device comprising:
a device buffer;
a filter management module including a content filter with a restricted term; and
a modification module arranged to:
determine that the content filter is enabled for the computing device;
identify a content container in the device buffer, the content container including the restricted term; and
modify the content container to block the restricted term by changing a portion of the content container that corresponds to the restricted term.

13. The computing device of claim 12, including:
a processing module arranged to use the content container; and
wherein the device buffer is arranged to store the content container prior to delivery of the content container to the processing module.

14. The computing device of claim 12, wherein the device buffer is a display buffer; and
wherein the processing module is arranged to render the content container on a display device.

15. The computing device of claim 13, wherein the device buffer is a network buffer; and
wherein the processing module is arranged to deliver network traffic to an application.

16. The computing device of claim 15, wherein the application is a web browser.

17. The computing device of claim 13, wherein the device buffer is a user interface input buffer for a user input device; and
wherein the processing module is arranged to deliver user input to an application.

18. The computing device of claim 12, wherein the portion of the content container includes renderable content; and
wherein the modification is arranged to prevent a renderer of the content container from rendering the restricted term.

19. The computing device of claim 12, wherein the content filter is arranged to be enabled for the computing device without regard to user-level applications that are at least one of running or installed on the computing device.

20. A method comprising:
determining that a content filter is enabled for a computing device, the content filter including a restricted term;
identifying a content container in a device buffer of the computing device, the content container including the restricted term; and
modifying the content container in the device buffer to block the restricted term by changing a portion of the content container corresponding to the restricted term.

21. The method of claim 20, wherein the device buffer is arranged to store the content container prior to delivery of the content container to a processing module.

22. The method of claim 21, wherein the device buffer is a display buffer; and
wherein the processing module is arranged to render the content container on a display device.

23. The method of claim 21, wherein the device buffer is a network buffer; and
wherein the processing module is arranged to deliver network traffic to an application.

24. The method of claim 23, wherein the application is a web browser.

25. The method of claim 24, wherein the web browser is arranged to use a proxy for encrypted communications, the proxy at a machine remote from a machine executing the web browser, the proxy arranged to make encrypted web requests on behalf of the web browser and to receive and decrypt encrypted responses directed toward the web browser.

26. The method of claim 21, wherein the device buffer is a user interface input buffer for a user input device; and
wherein the processing module is arranged to deliver user input to an application.

27. The method of claim 26, wherein the user input device is a keyboard.

28. The method of claim 27, wherein the keyboard is a soft-keyboard actuated by a touchscreen device.

29. The method of claim 20, wherein the portion of the content container includes renderable content; and
wherein the modification is arranged to prevent a renderer of the content container from rendering the restricted term.

30. The method of claim 20, wherein the content filter is enabled for the computing device without regard for user-level applications that are at least one of running or installed on the computing device.
